(19) United States
(12) Patent Application Publication
(10) Pub. No.: US 2010/0246971 A1
(43) Pub. Date: Sep. 30, 2010

(54) HOUSE CHANGE DETERMINING METHOD, HOUSE CHANGE DETERMINING PROGRAM, HOUSE CHANGE DETERMINING IMAGE GENERATING METHOD, AND HOUSE CHANGE DETERMINING IMAGE

(75) Inventors: Kazuyuki Ohtsubo, Niiza-shi (JP); Kenichi Baba, Fukuoka-shi (JP)

Correspondence Address: OLIFF & BERRIDGE, PLC, P.O. BOX 320850, ALEXANDRIA, VA, 22320-4850, US

(73) Assignee: PASCO CORPORATION, Tokyo (JP)

(21) Appl. No.: 12/739,834

(22) PCT Filed: Oct. 29, 2008
(86) PCT No.: PCT/JP2008/069610

§ 371 Date: Apr. 26, 2010

(30) Foreign Application Priority Data
Oct. 30, 2007 (JP) 2007-281276

(51) Int. Cl. G06K 9/46

(52) U.S. Cl. 382/195

(57) ABSTRACT

A method of judging a house change based on a comparison between high-resolution images or DSMs acquired from an aircraft is incapable of determining the house change in the region in which the DSM or the like is acquired for the first time. A house region in which a house exists is extracted from a judgment target region based on house polygon data acquired in advance at a time point T0. A feature region in which a feature exists is extracted based on a DSM acquired at a time point T1 after T0. The house region and the feature region are compared to obtain a difference region therebetween. The difference region is presented, to a judge, as a candidate region of house change occurrence between T0 and T1. An orthoimage data of an above-ground feature is combined with the candidate region for display.

### TECHNICAL FIELD

The present invention relates to a house change judgment method, a house change judgment program, a method of generating an image for house change judgment, and an image for house change judgment.

### BACKGROUND ART

The below-mentioned documents propose using aerial surveying technology to make a judgment or the like as to whether or not a fixed asset has been changed. Conventionally, a high-resolution image or digital surface model (DSM) data is acquired from an aircraft or the like at two different time points, and those images or pieces of data of the two time points are compared to each other, to thereby judge whether or not a house has been changed between the two time points.

### Patent Document 1: JP 2004-117245 A

### Patent Document 2: JP 2007-3244 A

### DISCLOSURE OF THE INVENTION

### Problems to be Solved by the Invention

In comparing high-resolution images, there is a problem that registration is difficult to perform with high accuracy, and also, there is a problem that it is difficult to set a threshold for judging whether or not there is a variation because pixel data, such as brightness value, varies depending on an image-taking condition or the like even if no variation has occurred in a house. For this reason, it is difficult to accurately perform automatic judgment regarding a house change, and a person may need to perform a task of spotting a variation in house by making a visual check of the entire image, which is troublesome.

Further, in order to make a judgment regarding a house change by comparing high-resolution images or DSMs, image-taking or data acquisition from above by an aircraft or the like needs to be performed not only at a time point at which a judgment result is required but also at a past time point, such as one year ago or so. Accordingly, there is a problem that, in a region for which the image-taking or the data acquisition has been performed for the first time, it is impossible to make a judgment regarding a house change until the image-taking or the data acquisition is performed again, for example, one year later.

The present invention has been made in order to solve the above-mentioned problems, and therefore has an object to provide a house change judgment method, a house change judgment program, a method of generating an image for house change judgment, and an image for house change judgment, which enable detection of a house change with a relatively low task load, even in a case where image-taking or data acquisition from above has been performed only once.

### Means for Solving the Problems

A house change judgment method according to the present invention includes: a house region extraction step of extracting a house region in which a house exists from a judgment target region based on house shape data acquired in advance; a feature region extraction step of extracting, based on digital surface model data expressed by an altitude of an above-ground surface including a feature, a feature region in which the feature exists, the digital surface model data being acquired from above with regard to each point within the judgment target region; and a candidate region presentation step of comparing the house region and the feature region to obtain a difference region therebetween, and presenting the difference region, to a person who makes a judgment regarding a house change, as a candidate region of house change occurrence between a time point at which the house shape data is acquired and a time point at which the digital surface model data is acquired.

The feature region extraction step may include a normalization step of subtracting, from the altitude indicated by the digital surface model data, an altitude of a ground surface excluding the feature, and generating height data of the feature, and the feature region extraction step may include extracting the feature region based on the height data of the feature.

In addition, the candidate region presentation step may include displaying a ground surface image photographed from above in the candidate region in a selective manner.

A house change judgment program according to the present invention causes a computer to execute: a house region extraction procedure of extracting a house region in which a house exists from a judgment target region based on house shape data acquired in advance; a feature region extraction procedure of extracting, based on digital surface model data expressed by an altitude of an above-ground surface including a feature, a feature region in which the feature exists, the digital surface model data being acquired from above with regard to each point within the judgment target region; and a candidate region presentation procedure of comparing the house region and the feature region to obtain a difference region therebetween, and presenting, to a person who makes a judgment regarding a house change, the difference region as a candidate region of house change occurrence between a time point at which the house shape data is acquired and a time point at which the digital surface model data is acquired.

A method of generating an image for house change judgment according to the present invention includes: a house region extraction step of extracting a house region in which a house exists from a judgment target region based on house shape data acquired in advance; a feature region extraction step of extracting, based on digital surface model data expressed by an altitude of an above-ground surface including a feature, a feature region in which the feature exists, the digital surface model data being acquired from above with regard to each point within the judgment target region; and an image-for-house-change-judgment generation step of comparing the house region and the feature region to obtain a difference region therebetween, setting the difference region as a candidate region of house change occurrence between a time point at which the house shape data is acquired and a time point at which the digital surface model data is acquired, and generating the image for house change judgment in which the candidate region is displayed in a discriminable manner in a ground surface image photographed from above.

The feature region extraction step may include a normalization step of subtracting, from the altitude indicated by the digital surface model data, an altitude of a ground surface excluding the feature, and generating height data of the feature, and the feature region extraction step may include extracting the feature region based on the height data of the feature.

The image for house change judgment may be an image in which the ground surface image is displayed in the candidate region in a selective manner, and the ground surface image is hidden in a region other than the candidate region.

An image for house change judgment according to the present invention is generated by the method of generating an image for house change judgment described above.

### EFFECT OF THE INVENTION

According to the present invention, by using the house shape data acquired in advance, it is possible to extract the candidate region in which the house has been changed based on the digital surface model (DSM) data obtained at a single time point. In general, the person who makes a judgment regarding a house change only needs to judge whether or not a house change has occurred in the candidate region, and hence a reduced task load may be achieved.

### BRIEF DESCRIPTION OF THE DRAWINGS

FIG. 1 is a flowchart illustrating a general flow of processing of a house change judgment method according to an embodiment of the present invention.

FIG. 2 are Schematic diagrams illustrating normalization processing with respect to a DSM.

FIG. 3 is a plan view schematically illustrating a binarized NDSM.

FIG. 4 is an explanatory diagram schematically illustrating planar shapes of houses which are displayed based on house polygon data.

FIG. 5 is a plan view schematically illustrating house raster data obtained in association with FIG. 4.

FIG. 6 is a plan view schematically illustrating candidate region data.

### BEST MODE FOR CARRYING OUT THE INVENTION

Hereinafter, description is given of a mode for carrying out the present invention (hereinafter, referred to as embodiment) with reference to the drawings.

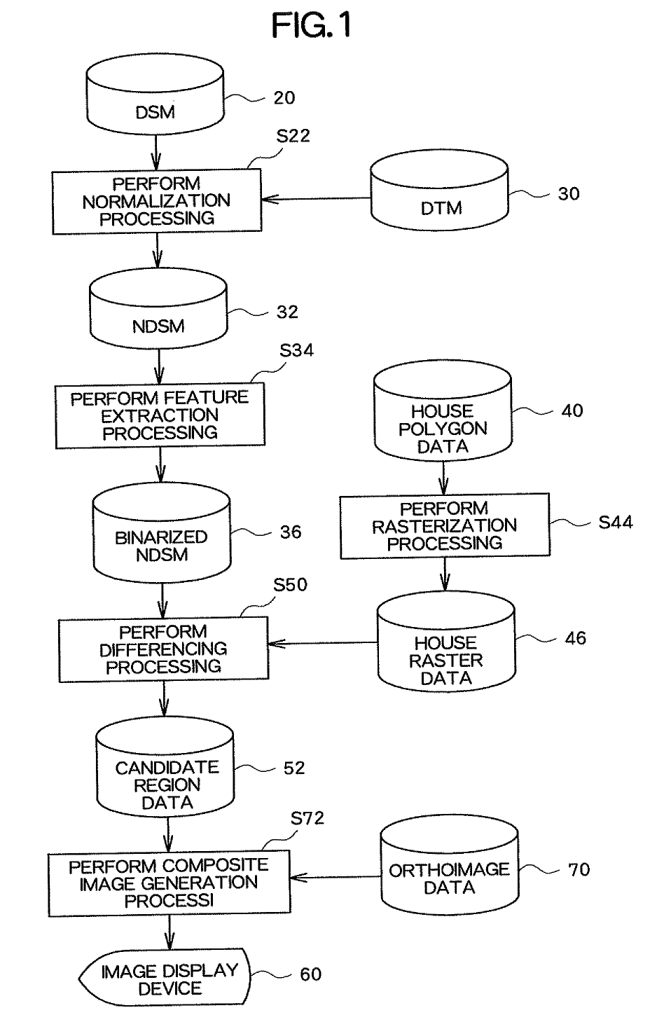

FIG. 1 is a flow chart illustrating a general flow of processing of a house change judgment method according to the embodiment. A DSM 20 acquired with regard to a judgment target region at a time point T1 is subjected to normalization processing S22. In the normalization processing S22, influence from a digital terrain model (DTM) contained in the DSM is removed.

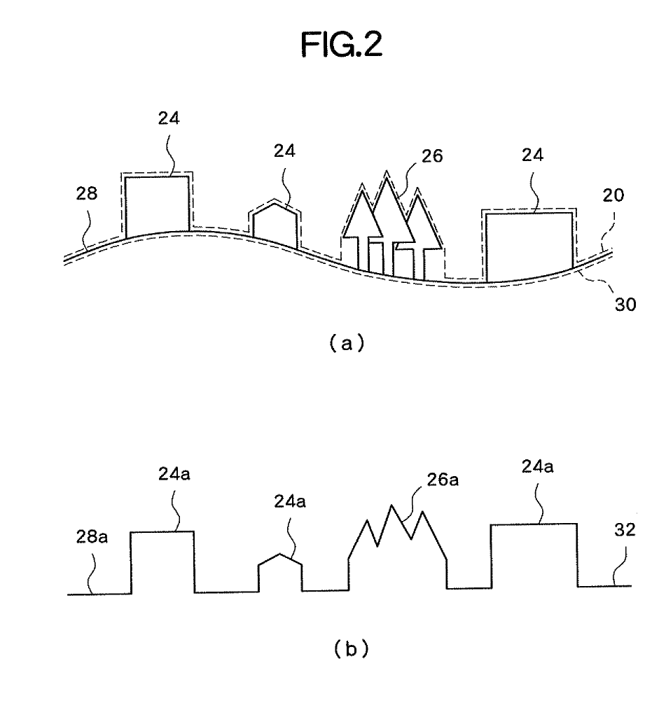

FIG. 2 are schematic diagrams illustrating the normalization processing. FIG. 2(a) is a schematic vertical cross section of above-ground features. The DSM 20 represents the horizontal coordinates/altitudes of surfaces of such features as houses 24 and trees 26, and the horizontal coordinates/altitudes of a ground surface 28 which is exposed between the features. Here, the altitude of a house in the DSM 20 is the sum of the altitude of the ground surface below the house and the height of the house. The normalization processing S22 is processing in which a value of a DTM 30 is subtracted from a value of the DSM 20, to thereby generate a normalized digital surface model (NDSM) 32. FIG. 2(b) is a vertical cross section schematically illustrating the NDSM 32 obtained in association with the above-ground features of FIG. 2(a). In the NDSM 32, the features (houses 24a and trees 26a) have height information from the ground surface, whereas a ground surface 28a basically has a height corresponding to a height of 0. For example, as the DTM 30, a model estimated from the DSM through various types of filtering processing may be used. Alternatively, an existing DTM regarding the judgment target region may be used.

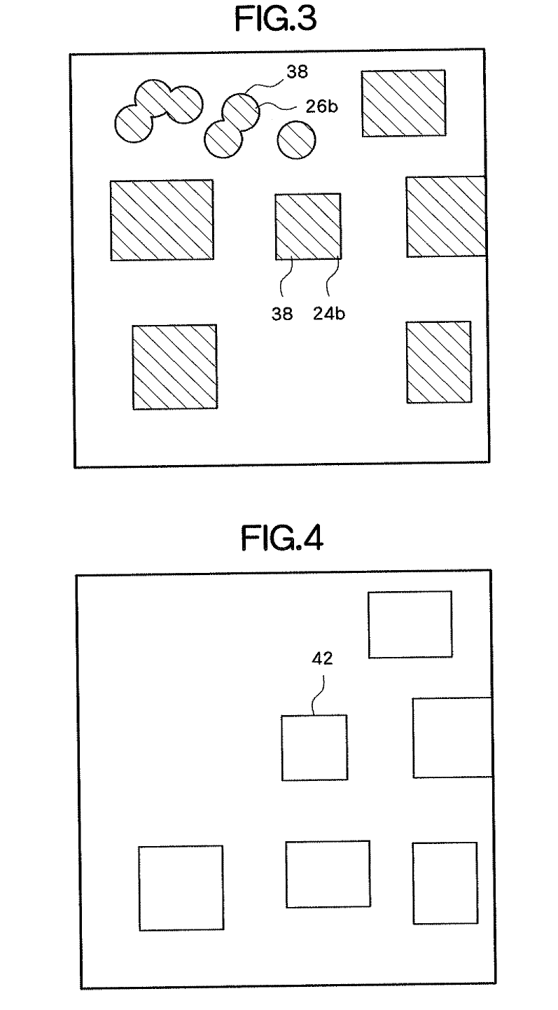

Next, as illustrated in FIG. 1, feature extraction processing S34 for extracting a region in which a feature exists (feature region) from the NDSM 32 obtained in the normalization processing S22 is performed. In the feature extraction processing S34, height data at each sampling point of the NDSM 32 is binarized by using a predetermined threshold, to thereby generate a binarized NDSM 36. The threshold is set to such a value that enables suitable discrimination between the ground surface 28a and the house 24a illustrated in FIG. 2. As the threshold, a value which is slightly smaller than a general height of a one-story house is suitable, and therefore may be set to approximately 3 m to 5 m, for example. FIG. 3 is a plan view schematically illustrating the binarized NDSM, in which feature regions 38 each corresponding to a region in which the houses 24a or the trees 26a as illustrated in FIG. 2(b) exist are extracted. In addition to regions 24b corresponding to the houses 24a of the NDSM 32, the feature regions 38 may also include, for example, regions 26b corresponding to the trees 26a. For example, in this embodiment, the binarized NDSM 36 has a value of “1” at pixels constituting the feature regions, and a value of “0” at pixels constituting the other region.

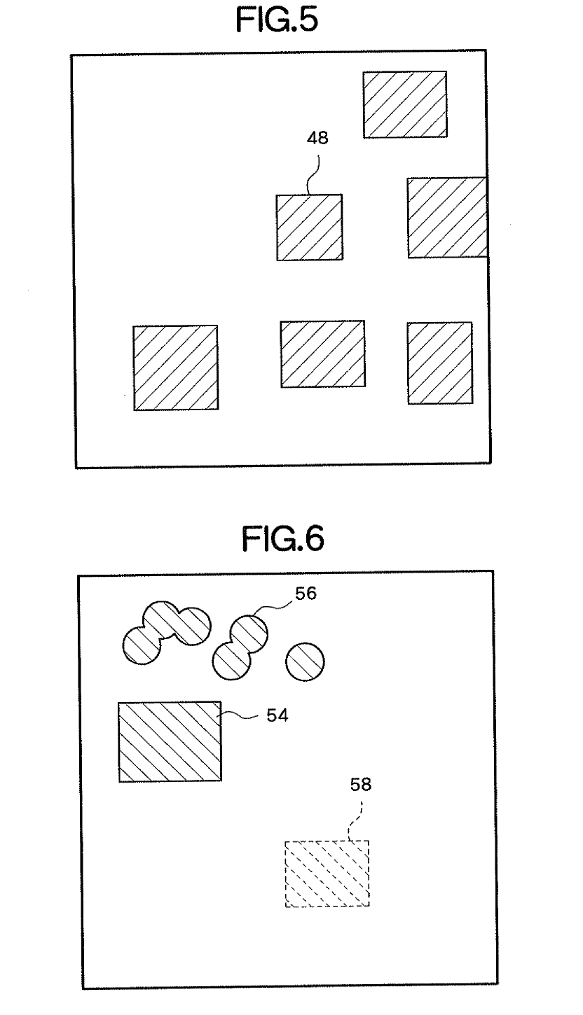

Meanwhile, with regard to the judgment target region, house polygon data 40 is acquired in advance at a time point T0 which precedes T1 (FIG. 1). The house polygon data 40 is expressed in vector form, and, as illustrated in FIG. 4, for example, the planar shape of a house is indicated by an outline frame 42 of the house. With respect to the house polygon data 40, a rasterization processing S44 is performed, to thereby generate house raster data 46. The house raster data 46 may be set as a binarized image in which different values are assigned between a region in which a house exists (house region) and the other region. For example, in this embodiment, the house raster data 46 has a value of “1” at pixels constituting the house region and a value of “0” at pixels constituting the other region. FIG. 5 is a plan view schematically illustrating the house raster data 46 obtained in association with FIG. 4, in which house regions 48 are indicated with the hatched lines.

Note that although description has been given of a configuration in which house shape data acquired in advance serves as the house polygon data 40, the house shape data may be the house raster data 46. For example, if the house raster data 46 generated from the house polygon data 40 is stored, and, in the following house change judgment processing, the house raster data 46 is used as the house shape data, there is no need to perform the rasterization processing S44 for each house change judgment processing.

Next, the binarized NDSM 36 and the house raster data 46 are compared to obtain difference regions between the two (differencing processing S50 of FIG. 1), and then candidate region data 52 indicating the difference regions is generated. For example, data of each pixel of the candidate region data may be set to a value obtained by subtracting a value of the house raster data 46 from a value of the binarized NDSM 36 at the corresponding pixel. With this configuration, a region corresponding to a house which has been newly constructed between the time points T0 and T1 is assigned a pixel value of “1”, a region in which a house has disappeared is assigned a pixel value of “−1”, and a region in which no variation has occurred is assigned a pixel value of “0”. FIG. 6 is a plan view schematically illustrating the candidate region data 52. In FIG. 6, a region 54 in which a house has been newly constructed, and other new feature regions 56, are assigned the pixel value of “1” which indicates candidate regions of new construction, and a region 58 in which a house has disappeared is assigned the pixel value of “−1”, which indicates a candidate region of disappearance.

The candidate region data 52 is displayed as an image on an image display device 60, and the candidate regions are presented to a person who makes a judgment regarding a house change. With this configuration, the person who makes a judgment regarding a house change can essentially detect a house change by examining a portion corresponding to the candidate region in a high-resolution above-ground image or the like. In other words, there is no need to examine the entirety of a high-resolution image, and hence the workload for the person who makes a judgment regarding a house change may be reduced. For example, at the time of displaying the candidate region data 52 as an image, the candidate region of new construction and the candidate region of disappearance may be displayed in a discriminable manner by using different colors, which allows the person who makes a judgment regarding a house change to perform the change judgment more easily.

Further, in this embodiment, a composite image may be generated based on the image representing the candidate region data 52 and, for example, an orthoimage representing orthoimage data 70 of the above-ground features which is created when the DSM is acquired at the time point T1 (composite image generation processing S72 illustrated in FIG. 1), and may be displayed on the image display device 60. For example, in the composite image, the orthoimage may be displayed in a selective manner in the candidate region of new construction or the candidate region of disappearance, and the other region may be set as an image in which the orthoimage is masked. With this configuration, the person who makes a judgment regarding a house change can confirm the new construction or the disappearance of a house in the candidate region more easily based on the orthoimage. For example, the candidate region of new construction may include the feature region 56 which is not a house as described above, but if the orthoimage is superimposed onto the candidate region of new construction and displayed, it becomes possible to discriminate between the region 54 corresponding to the newly-constructed house and the other feature region 56.

Note that for the composite image, another mode may be employed, such as a mode in which the outline of the candidate region is superimposed onto the orthoimage for display.

The above-mentioned house change judgment method may be implemented as a program to be executed on a computer. By executing the program, the computer extracts the feature region 38 in which a feature exists from the judgment target region based on the DSM 20 acquired by an aircraft or the like, and on the other hand, extracts the house region 48 in which a house exists from the judgment target region based on the house polygon data 40. Then, the computer compares the house region 48 and the feature region 38, and then displays, on the image display device 60, a difference region therebetween as a candidate region of house change occurrence between the time point T0 at which the house polygon data 40 is acquired and the time point T1 at which the DSM 20 is acquired, to thereby present the candidate region to the person who makes a judgment regarding a house change. On this occasion, the computer may also perform processing in which an orthoimage of an above-ground feature which is obtained from the orthoimage data 70 is combined with the candidate region for display in a selective manner.

Further, in the above-mentioned embodiment, description has been given of a case where the composite image to be presented to the person who makes a judgment regarding a house change (image for house change judgment) is displayed on the image display device 60 such as a display, but the image for house change judgment may be printed on such a medium as paper.

1. A house change judgment method, comprising:
a house region extraction step of extracting a house region in which a house exists from a judgment target region based on house shape data acquired in advance;
a feature region extraction step of extracting, based on digital surface model data expressed by an altitude of an above-ground surface including a feature, a feature region in which the feature exists, the digital surface model data being acquired from above with regard to each point within the judgment target region; and
a candidate region presentation step of comparing the house region and the feature region to obtain a difference region therebetween, and presenting, to a person who makes a judgment regarding a house change, the difference region as a candidate region of house change occurrence between a time point at which the house shape data is acquired and a time point at which the digital surface model data is acquired.

2. The house change judgment method according to claim 1, wherein:
the feature region extraction step comprises a normalization step of subtracting, from the altitude indicated by the digital surface model data, an altitude of a ground surface excluding the feature, and generating height data of the feature; and
the feature region extraction step comprises extracting the feature region based on the height data of the feature.

3. The house change judgment method according to claim 1, wherein the candidate region presentation step comprises displaying a ground surface image photographed from above in the candidate region in a selective manner.

4. A house change judgment program for causing a computer to execute:
a house region extraction procedure of extracting a house region in which a house exists from a judgment target region based on house shape data acquired in advance;
a feature region extraction procedure of extracting, based on digital surface model data expressed by an altitude of an above-ground surface including a feature, a feature region in which the feature exists, the digital surface model data being acquired from above with regard to each point within the judgment target region; and
a candidate region presentation procedure of comparing the house region and the feature region to obtain a difference region therebetween, and presenting, to a person who makes a judgment regarding a house change, the difference region as a candidate region of house change occurrence between a time point at which the house shape data is acquired and a time point at which the digital surface model data is acquired.

5. A method of generating an image for house change judgment, comprising:
a house region extraction step of extracting a house region in which a house exists from a judgment target region based on house shape data acquired in advance;
a feature region extraction step of extracting, based on digital surface model data expressed by an altitude of an above-ground surface including a feature, a feature region in which the feature exists, the digital surface model data being acquired from above with regard to each point within the judgment target region; and
an image-for-house-change-judgment generation step of comparing the house region and the feature region to obtain a difference region therebetween, setting the difference region as a candidate region of house change occurrence between a time point at which the house shape data is acquired and a time point at which the digital surface model data is acquired, and generating the image for house change judgment in which the candidate region is displayed in a discriminable manner in a ground surface image photographed from above.

6. The method of generating an image for house change judgment according to claim 5, wherein:
the feature region extraction step comprises a normalization step of subtracting, from the altitude indicated by the digital surface model data, an altitude of a ground surface excluding the feature, and generating height data of the feature; and
the feature region extraction step comprises extracting the feature region based on the height data of the feature.

7. The method of generating an image for house change judgment according to claim 5, wherein the image for house change judgment comprises an image in which the ground surface image is displayed in the candidate region in a selective manner, and the ground surface image is hidden in a region other than the candidate region.

8. An image for house change judgment, which is generated by the method of generating an image for house change judgment according to claim 5.
